(19) United States
(12) Patent Application Publication
(10) Pub. No.: US 2014/0331937 A1
(43) Pub. Date: Nov. 13, 2014

(54) Animal Watering Device

(71) Applicant: Paul Pluss, Ramona, CA (US)

(72) Inventor: Paul Pluss, Ramona, CA (US)

(73) Assignee: THE EASY CLEAN WATER BOWL, LLC, Ramona, CA (US)

(21) Appl. No.: 14/361,059

(22) PCT Filed: Dec. 17, 2012
(86) PCT No.: PCT/US12/70195

§ 371 Date: May 28, 2014

Related U.S. Application Data
(60) Provisional application No. 61/576,898, filed on Dec. 16, 2011.

(51) Int. Cl. A01K 7/04

(52) U.S. Cl. CPC A01K 7/04
USPC 119/78

(57) ABSTRACT

Provided herein are animal watering devices that reduce water consumption and microorganism contamination.

### CROSS-REFERENCE TO RELATED PATENT APPLICATIONS

This application claims the benefit of priority to U.S. Provisional Patent Application Ser. No. 61/576,898, filed Dec. 16, 2011 and entitled “Animal Watering Device”; the entirety of which is incorporated by reference.

### FIELD OF THE INVENTION

This invention relates generally to animal watering devices, and more particularly to an automatic watering dish.

### BACKGROUND OF THE INVENTION

Fresh, clean water is tantamount to good health. Automatic watering devices are known in the art for maintaining a ready supply of water for animals and alleviating the time-consuming chore of filling water bowls, particularly when raising many animals. Some of these devices utilize float controlled valves or similar devices for detecting a drop in the water level of the drinking reservoir, and for releasing water into the reservoir from a water supply until the reservoir has been replenished.

There is a need for such devices that minimize contamination by microorganisms for animal health, such as by providing a fluid contact surface that is easily cleaned. There is also a need for such devices that minimize water wastage.

### SUMMARY OF THE INVENTION

Provided herein is an animal watering device. Several views of one embodiment are provided in FIGS. 1-5. Said animal watering device includes as represented in FIG. 5 (a) a fluid receptacle 1 that has one or more side walls and a bottom wall and is in fluid communication with a float tray 2, wherein the bottom of the float tray 2 can be sloped toward said fluid receptacle 1; (b) a float assembly including a float 3 (which can be comprised of two or more parts for ease of production, such as 3-A and 3-B as shown in FIG. 5) which can be attached in a fixed orientation to a float cover 4, wherein the float assembly is connected to the float tray 2 via a hinge on the float assembly; and, (c) an inlet valve 5 operatively connected to the float assembly for supplying fluid to the float tray 2, wherein the float 3 actuates the valve 7 when the float 3 rises to a predetermined height. The fluid receptacle 1 and float tray 2 can be integrally formed. The hinge on the float assembly allows movement of the float assembly at least 30, 45, 60 or 90 degrees away from the float tray 2. The hinge on the float assembly can be attached to the float cover 4 or to the float 3. The float assembly can be detachable from the float tray 2. The fluid receptacle 1 can be configured to have no angles between the interior sidewalls and no angles between interior sidewalls and the bottom wall. The fluid receptacle 1 can be configured to have no flat surfaces. The animal watering device can further include at least one mounting bracket 9, which can be integrally formed with the fluid receptacle 1 or the float tray 2. The mounting bracket can be attached to a mount which can be a wall mount, a post mount or a hanging mount.

“Integrally formed” means that one or more parts are formed from a single piece. This is to be distinguished from where two or more pieces are assembled, such as being bolted together.

A “fluid receptacle” refers to a container that can hold fluids such as water, such as a bowl.

As used herein, “baffling” refers to a device that regulates the flow of a fluid. For example, a baffle can be a flow-directing vane or panel in a vessel, e.g. a float tray, such as a static mixer.

“Dishwasher safe” means that the material can be placed in an automatic dishwasher and not be warped by the temperatures the material is subjected to by the automatic dishwasher.

### BRIEF DESCRIPTION OF THE DRAWINGS

FIG. 1 is a side view of the animal watering device with a cutaway view of the float tray.

FIG. 2 is a side view of the animal watering device demonstrating the float and float cover in the down position.

FIG. 3 is a side view of the animal watering device demonstrating the float and float cover in the partially raised position.

FIG. 4 is a perspective view of the animal watering device demonstrating (float in the down position).

FIG. 5 is an exploded perspective view of the animal watering device.

FIG. 6 shows top and side views of the animal watering device.

FIG. 7 shows perspective, top and side views of the float cover.

FIG. 8 shows perspective, top and side views of one piece of the two-piece float.

FIG. 9 shows perspective, top and side views of the other piece of the two-piece float.

FIG. 10 shows a photograph of the animal watering device attached to a wall mount.

FIG. 11 shows a photograph of the animal watering device attached to a post mount.

FIG. 12 shows a photograph of the animal watering device attached to a hanging mount.

FIG. 13 shows an exploded perspective view of another embodiment of the animal watering device showing a skirted bowl, heating element, and anti-skid strips.

### DETAILED DESCRIPTION OF THE INVENTION

Provided herein are improved automatic watering devices. Many prior art watering dishes have a valve controlling the release of water from the water supply and into the drinking reservoir which is in turn controlled by a float mounted on a pivoting arm. The float assembly is typically housed in a reservoir separate, but in fluid communication with, the drinking reservoir. However, it is often the case that the float reservoir contains a large volume of water to house or chamber the float. This is both wasteful with respect to the amount of water that is exposed but not available for drinking and it is another collection area for agents of water borne diseases. Furthermore, the housing for the float assembly is not easily user accessible thereby inhibiting the cleaning of the float reservoir.

With regard to the drinking reservoir, prior art configurations have a flat bottom so that the dish can be steadied on a flat surface, e.g. a floor. However, these dishes have sharp angles between the bottom and sides of the bowl (and if the drinking receptacle is rectangular or other rectilinear shape, will have sharp angles between the sides). These sharp angles make the drinking reservoir hard to clean and are at increased risk of harboring microorganisms related to water-borne diseases.

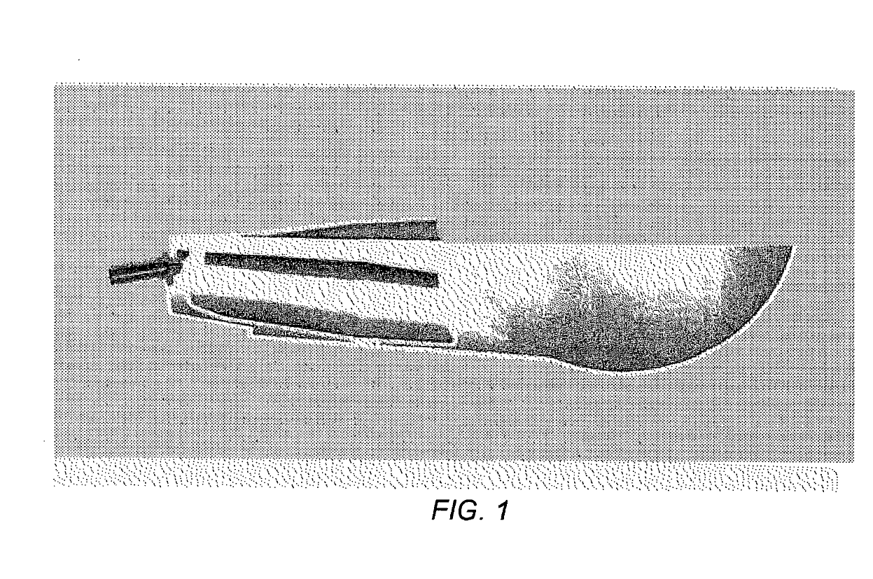

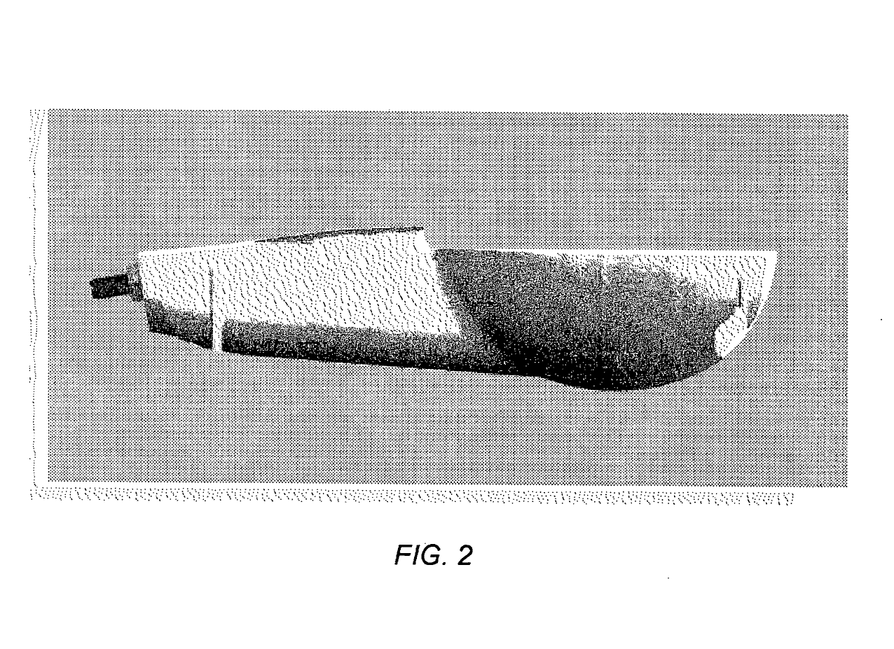

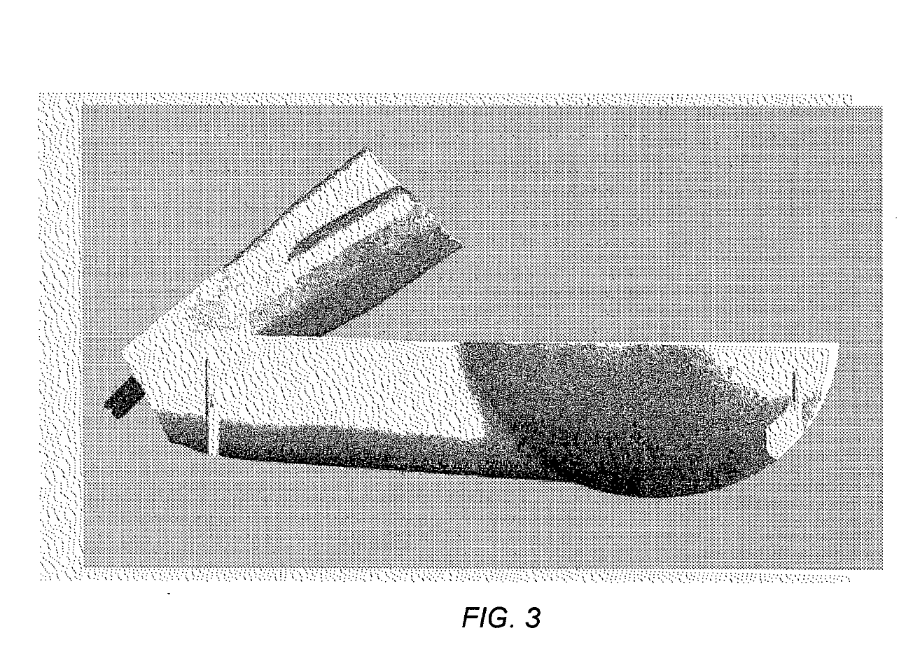

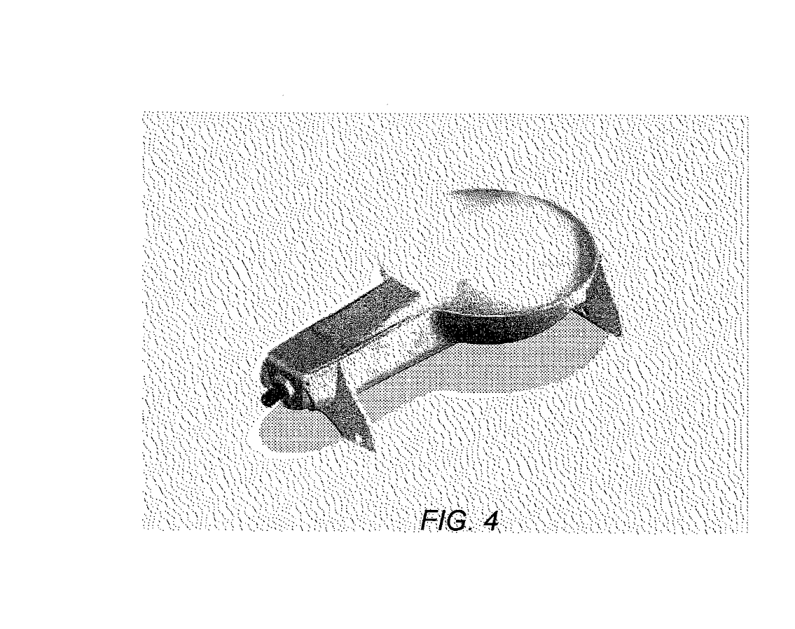

FIG. 1 illustrates the animal watering device with a cutaway view of the float tray to show the relative orientation of the float within it. FIG. 2 illustrates the same perspective without the cutaway. FIG. 3 illustrates the same perspective as FIG. 2, but shows that the float and float cover can be tilted upward and away from the float tray. FIG. 4 is a perspective drawing of the animal watering device.

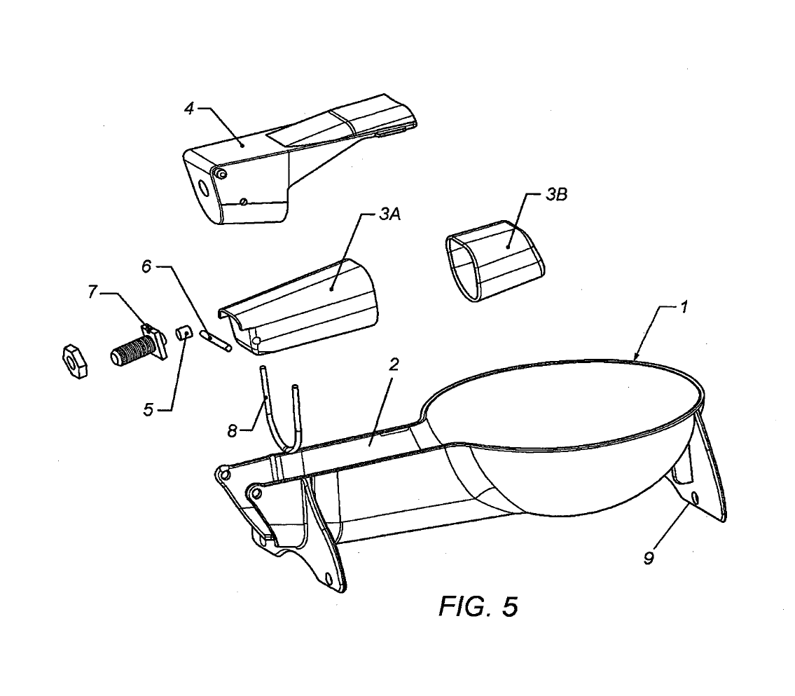

FIG. 5 illustrates the animal watering device in an exploded view. The fluid receptacle 1 provides an open bowl from which an animal can drink. The fluid receptacle 1 is made of sidewalls and a bottom wall in any configuration that allows the fluid receptacle to retain fluid. In an embodiment, the fluid receptacle 1 is dimensioned such that it has no angles between the sidewalls and has no angles between the sidewalls and the bottom wall. This configuration is more readily cleanable and less prone to harboring microorganisms. The fluid receptacle can be skirted to improve stability when placed on a flat surface and to discourage the animal from grabbing the fluid receptacle with its teeth.

The fluid receptacle 1 and the float tray 2, here shown in a unitary configuration, are in fluid communication with each other. In an embodiment, the float tray 2 is sloped toward the fluid receptacle 1. In an embodiment, there is no ridge or interruption between the float tray 2 and the fluid receptacle 1.

The float cover 4 holds the float 3, thereby comprising the float assembly.

The float 3 can have a stopper 5. The stopper 5 can be disposed in a recessed pocket of the float. The stopper 5 can be made of any water resilient material for blocking the passage of water, such as rubber or silicone. When water lifts the float 3 on its hinge 6 the stopper 5 closes the water inlet port 7. As the water level subsides, the weight of the float 3 retracts the stopper 5 from the inlet valve. The length of the stopper 5 can be modified to adjust water level in the float tray 2. The inlet 7 is equipped with a suitable connector that allows the water inlet port 7 to be attached to a water source. The connector can be, but is not limited to, a threaded connector or a quick-disconnect connector. The connector can be any suitable material, such as brass. The water level in the float tray 2 is monitored by the float 3. The float 3 is preferably made out of a buoyant material or hollow casting, such as foamed polystyrene or a similar plastic that does not readily absorb water and may be cast, molded, stamped, or carved into a convenient shape. In an embodiment, the float comprises a substantial volume of the interior of the float tray 2. The float 3 can comprise at least 70, at least 80, at least 90 or at least 95% of the float tray 2 interior volume. In other embodiments, the distance between the surface of the float 3 in opposition to the surface of the float tray 2 when empty of fluid can be less the 1, less than 0.5, or less than 0.2 cm. The float tray gasket 8, prevents water from leaking out of the float tray 2. The float 3, which rides the surface of the water within the float tray 2, is attached to float cover 4 that manipulates the valve 5 within the inlet 7.

The float cover 4 or the float 3 itself can be hingeably attached to the float tray 2 In an embodiment, the hinge 6 allows the user to swing up the float assembly away from the float tray 2. This allows the user to readily clean the float tray 2 without disconnecting the water supply and without having to remove a reservoir cover, preferably without the use of tools. The float assembly can be hinged such that the float assembly can be lifted at least 30, at least 45, at least 60, or at least 90 degrees away from the bottom of the float tray 2. In some embodiments the hinge 6 is detachable, such as a snap-in hinge. In other embodiments, the float cover snaps closed with a pressure sensitive latch that does not require additional hardware or does not require the use of tools.

In an embodiment, the float 3 can be dimensioned so that the side of the float 3 proximal to the fluid receptacle 1 forms a portion of a side wall of the fluid receptacle 1. In this way, when the float assembly is not raised, the user can fluidly clean the interior surface of the fluid receptacle and the edge of the float 3 that the animal directly contacts when drinking. In another embodiment, the float 3 can further include baffling so as to quell rushing water that fills the float tray 2.

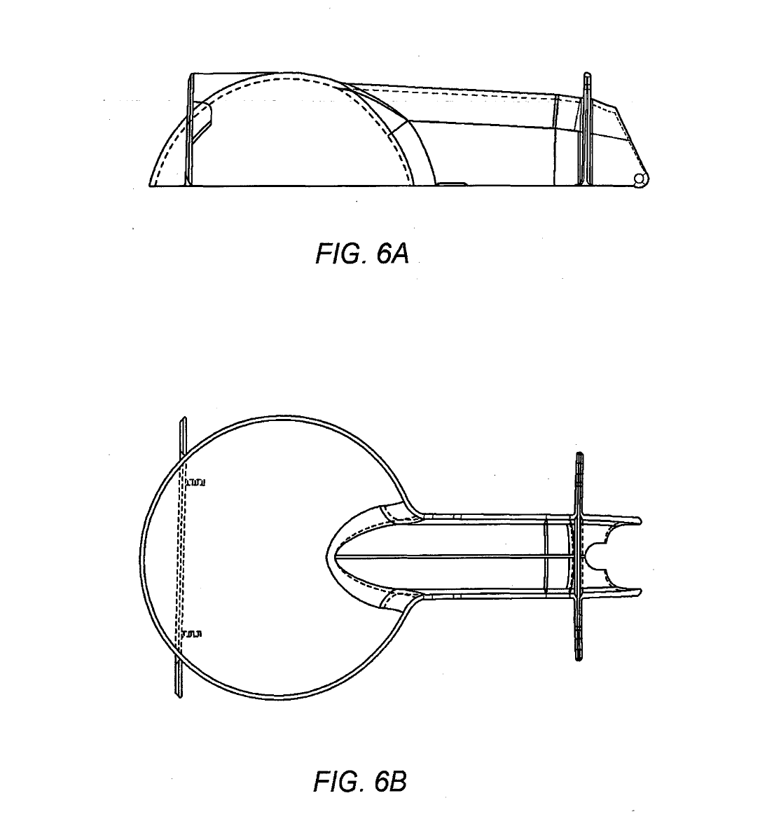

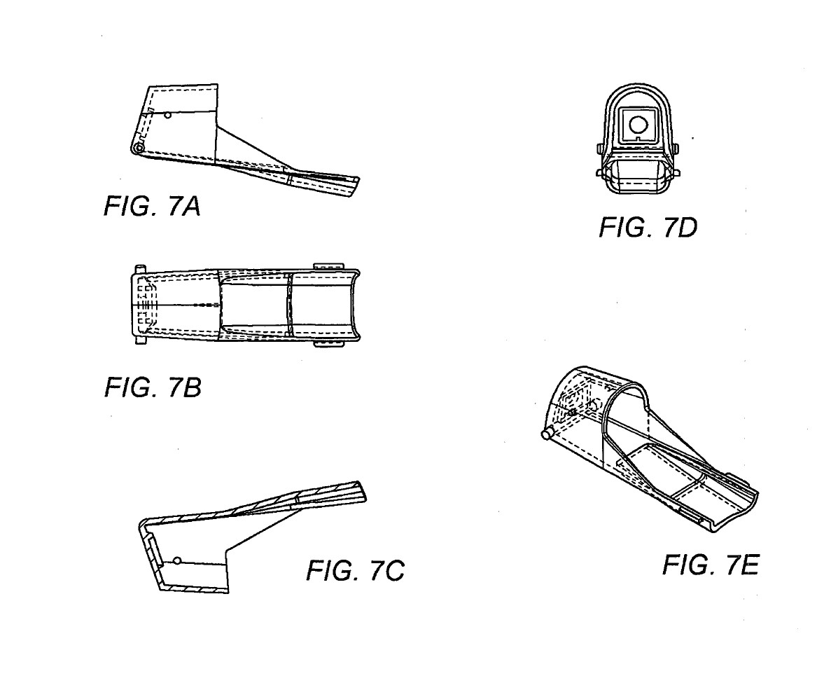

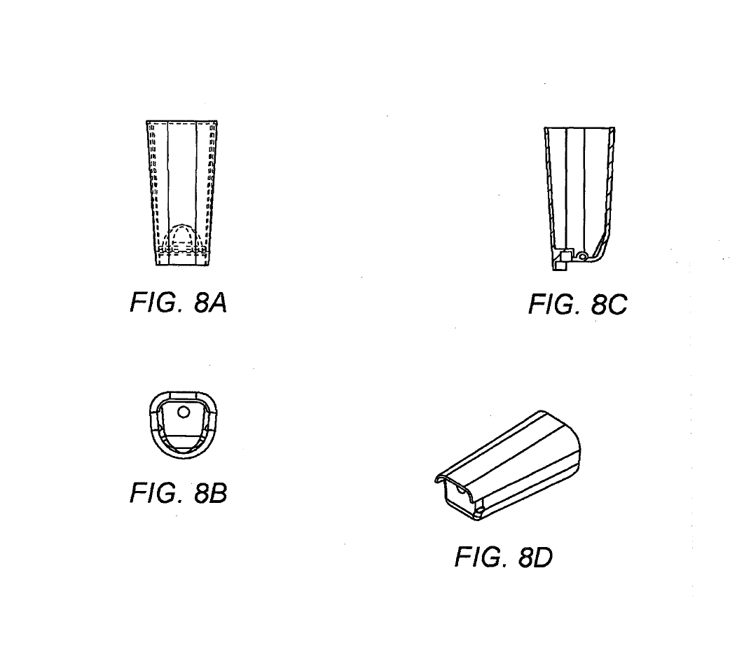

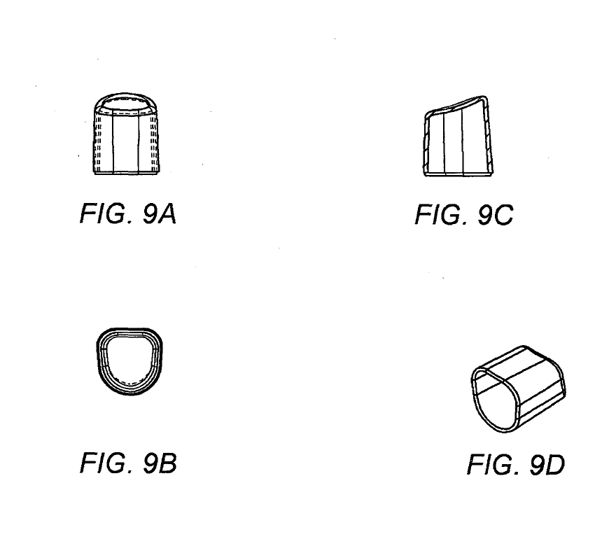

FIG. 6 shows, in an embodiment, relative dimensions of the fluid receptacle 1, float tray 2 and mounting brackets 9. FIG. 7 further illustrates the float cover 4 with hinge placement. FIG. 8 and FIG. 9 further illustrate, in an embodiment, the two parts of the float 3, comprising 3-A and 3-B.

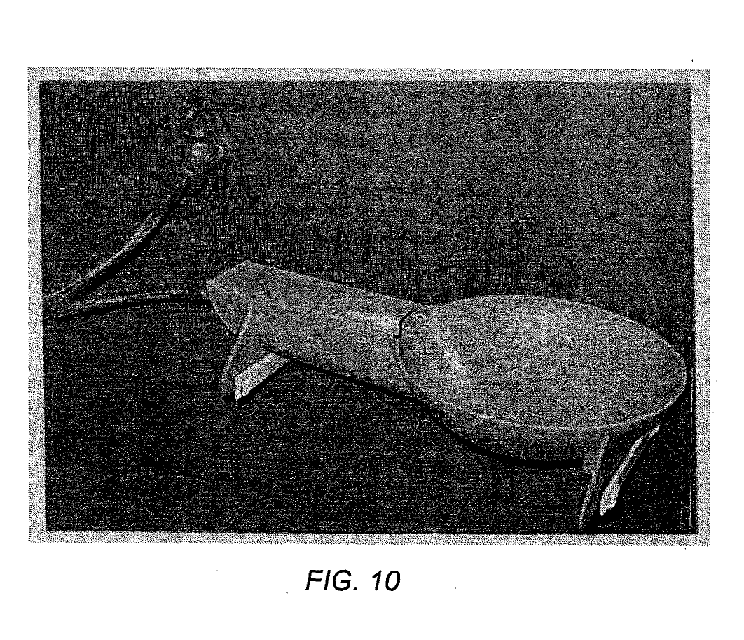

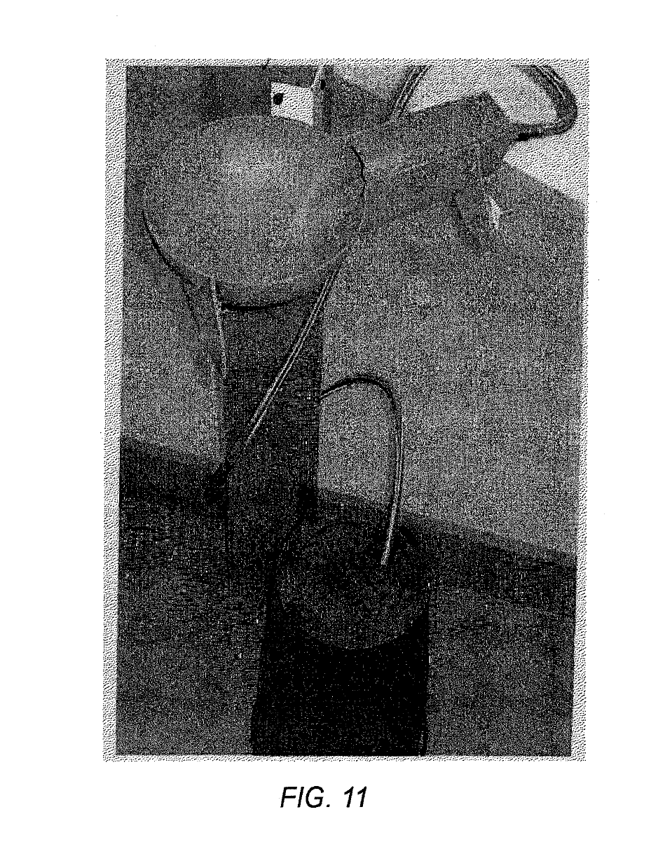

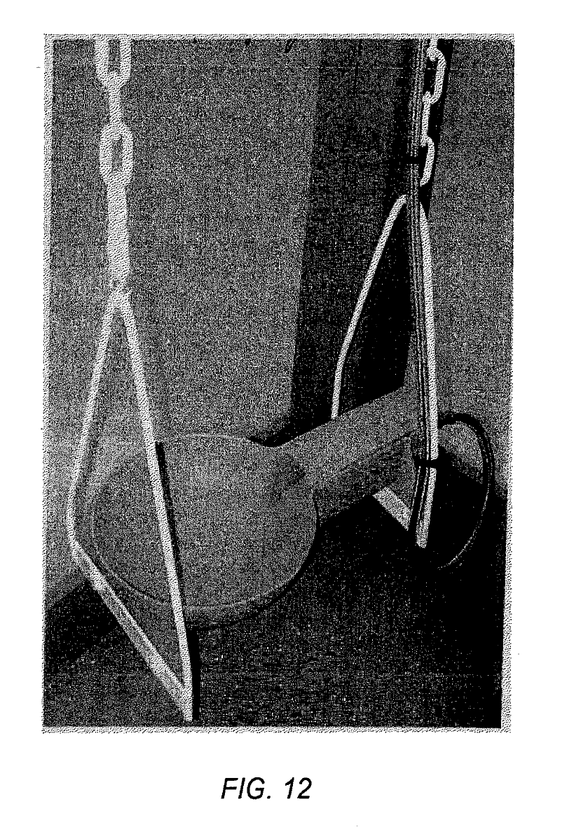

The animal watering device can further include one or more mounting brackets 9. These mounting brackets 9 can be used, in various embodiments, to attach the animal watering device to a wall mount (FIG. 10), a post mount (FIG. 11), or a hanging mount (FIG. 12).

The animal watering device can be constructed out of one or more many suitable materials as are known to the art, such as a tough, rigid plastic such as polyvinylchloride or an appropriate grade of polyethylene, or of stainless steel. In certain embodiments, one or more parts are dishwasher-safe. Various fillers or pigments can be used to confer a desired color or texture to the material used for the construction of the dish. The dish may also be decorated with decals or designs to improve its aesthetic appeal.

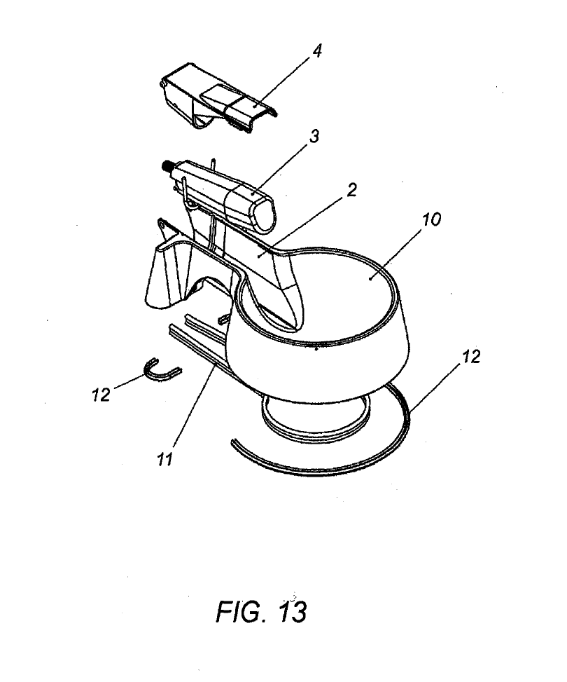

The animal watering device can further include a heat source to prevent the fluid (usually water) from freezing in frigid environments. Heat sources can include, for example, discharge electrodes, heating filaments, heating coils, hot water jackets, hot air generators, infrared lamps and a variety of other thermal transfer elements. The animal watering device can include anti-skid material (e.g. rubber or silicone) on surfaces of the device that contact the mounting surface, such as a floor. FIG. 13 shows an embodiment of the invention having a skirted fluid receptacle, a heating element, and anti-skid strips.

The above disclosure is intended only to convey an understanding of the present invention to those skilled in the art, and is not intended to be limiting. It will be appreciated that various modifications to the disclosed embodiments are possible without departing from the scope of the invention. Therefore, the scope of the present invention should be construed solely by reference to the appended claims.

What is claimed is:

1. An animal watering device comprising:
(a) a fluid receptacle 1, said fluid receptacle comprising one or more side walls and a bottom wall and in fluid communication with a float tray 2, wherein the bottom of said float tray is sloped toward said fluid receptacle;
(b) a float assembly, said float assembly comprising a float 3 attached in a fixed orientation to a float cover 4, wherein said float assembly is connected to said float tray 2 via a hinge; and,
(c) a water inlet port 7 operatively connected to said float assembly for supplying fluid to said float tray 2, wherein said float 3 actuates said water inlet port 7 when said float 3 rises to a predetermined height.

2. The animal watering device of claim 1, wherein said hinge allows movement of said float assembly at least 60 degrees away from the surface of said float tray 2.

3. The animal watering device of claim 1, wherein said hinge is attached to said float cover 4.

4. The animal watering device of claim 1, wherein said float assembly is detachable from said float tray 2.

5. The animal watering device of claim 1, wherein said fluid receptacle 1 and said float tray 2 are integrally formed.

6. The animal watering device of claim 1, wherein the surface of said float 3 that is in opposition to said float tray 2 is less than 0.5 cm away from the surface of said float tray 2 when there is no fluid in said float tray 2.

7. The animal watering device of claim 1, wherein said float 3 occupies at least 90% of the volume of said float tray 2.

8. The animal watering device of claim 1, wherein the outer surface of said float 3 further comprises baffling.

9. The animal watering device of claim 1, wherein the side of said float 3 proximal to said fluid receptacle 1 forms a portion of a side wall of said fluid receptacle 1.

10. The animal watering device of claim 1, wherein said water inlet port 7 is attached to and in fluid communication with a water supply connector.

11. The animal watering device of claim 10, wherein said water supply connector is selected from the group consisting of a threaded connector and a quick-disconnect connector.

12. The animal watering device of claim 1, wherein said fluid receptacle 1 has no angles between said sidewalls and has no angles between sidewalls and said bottom wall of said fluid receptacle 1.

13. The animal watering device of claim 1, wherein said fluid receptacle 1 and said float tray 2 are dishwasher safe.

14. The animal watering device of claim 1, wherein said fluid receptacle 1 and float tray 2 are comprise plastic.

15. The animal watering device of claim 1, further comprising at least one mounting bracket 9.

16. The animal watering device of claim 15, wherein said at least one mounting bracket 9, said fluid receptacle 1 and said float tray 2 are integrally formed.

17. The animal watering device of claim 16, wherein said mounting bracket 9 is attached to a mount.

18. The animal watering device of claim 17, wherein said mount is selected from the group consisting of: a wall mount, a post mount and a hanging mount.

19. The animal water device of claim 1, further comprising a heat source.

20. The animal water device of claim 1, wherein said fluid receptacle is skirted.
